(19) United States
(12) Patent Application Publication
(10) Pub. No.: US 2026/0150997 A1
(43) Pub. Date: Jun. 4, 2026

(54) NONSTICK PAN

(71) Applicant: ZHEJIANG SANHE KITCHENWARE CO., LTD., Cixi (CN)

(72) Inventors: FeiYong TANG, Cixi (CN); BingCai XIONG, Cixi (CN); Cheng FANG, Cixi (CN)

(73) Assignee: ZHEJIANG SANHE KITCHENWARE CO., LTD., Cixi (CN)

(21) Appl. No.: 19/023,513

(22) Filed: Jan. 16, 2025

(30) Foreign Application Priority Data
Dec. 4, 2024 (CN) 202411770429.9

(51) Int. Cl. A47J 36/02; A47J 27/00

(52) U.S. Cl. CPC A47J 36/025; A47J 27/002

(57) ABSTRACT

A nonstick pan includes a metal pan body, where an inner surface of the pan body is provided with dimples to form a concave-convex portion on the inner surface of the pan body; the pan body is subject to a pre-treatment process to form a hard layer with pores on the inner surface of the pan body; the hard layer has a hardness of 500 HV or above; the hard layer is covered with a transparent closing and connection layer to seal the pores of the hard layer; the closing and connection layer partially enters a part of the pores of the hard layer to firmly bond to the hard layer; and the closing and connection layer is sprayed with an inorganic nonstick coating, and the inorganic nonstick coating is bonded to the closing and connection layer.

### CROSS REFERENCE TO THE RELATED APPLICATIONS

This application is based upon and claims priority to Chinese Patent Application No. 202411770429.9, filed on Dec. 4, 2024, the entire contents of which are incorporated herein by reference.

### TECHNICAL FIELD

The present disclosure relates to a nonstick pan.

### BACKGROUND

U.S. Pat. No. 10,194,771B2 discloses a nonstick pan. The inner surface of the pan body of the nonstick pan is provided with ribs, and grooves are formed between the ribs. Additionally, the inner surface of the pan body is provided with a nonstick coating. The thicknesses of the nonstick coating on the ribs and in the grooves are subject to a specific constraint condition, offering the nonstick pan a good nonstick effect. However, the nonstick pan has the following drawbacks. The nonstick effect depends solely on the nonstick coating, but the nonstick coating in this patent is directly coated on the inner surface of the pan body, leading to poor adhesion between the nonstick coating and the pan body. As a result, the nonstick coating is easy to detach. Once the nonstick coating detaches, the nonstick effect will be greatly reduced.

U.S. Pat. No. 10,258,184B2 discloses a nonstick pan. The inner surface of the pan body of the nonstick pan is provided with solid and dashed ribs, forming a specific concave-convex pattern. A nonstick coating is provided in concave portions. The concave-convex pattern increases the heat transfer area to achieve fast cooking. Due to the fact that the concave portions occupy the majority of the area in this design, the nonstick effect of the nonstick pan is still achieved through the nonstick coating. Similarly, the nonstick coating in this patent is directly coated on the inner surface of the pan body, leading to poor adhesion between the nonstick coating and the pan body. As a result, the nonstick coating is easy to detach. Once the nonstick coating detaches, the nonstick effect will be greatly reduced.

### SUMMARY

In order to overcome the above-mentioned shortcomings of the existing nonstick pans, the present disclosure provides a nonstick pan with better nonstick effect.

In order to solve the technical problem, the present disclosure adopts the following technical solution. A nonstick pan includes a metal pan body, where an inner surface of the pan body is provided with dimples to form a concave-convex portion on the inner surface of the pan body;

the pan body is subject to a pre-treatment process to form a hard layer with pores on the inner surface of the pan body, and the hard layer has a hardness of 500 HV or above;

the hard layer is covered with a transparent closing and connection layer to seal the pores of the hard layer, and the closing and connection layer partially enters a part of the pores of the hard layer to firmly bond to the hard layer; and

the closing and connection layer is sprayed with an inorganic nonstick coating, and the inorganic nonstick coating is bonded to the closing and connection layer.

Furthermore, the dimples are uniformly distributed on the inner surface of the pan body; and the dimples have a maximum width of 0.5 mm-1.5 mm, a spacing of 0.3 mm-1 mm, and a depth of 0.05 mm-0.15 mm;

the hard layer has a thickness of 25 μm-45 μm;

the closing and connection layer has a thickness of 1 μm-2 μm; and

the inorganic nonstick coating has a thickness of 0.5 μm-1.5 μm.

Furthermore, the closing and connection layer is made of polysilazane.

Furthermore, after a material of the inorganic nonstick coating is sprayed onto the closing and connection layer, sintering is performed at 280° C.-320 ° C. for 8 min-12 min.

Furthermore, the inner surface of the pan body is made of iron, and the pre-treatment process is gas nitriding to form a nitrided layer on the inner surface of the pan body; and the nitrided layer forms the hard layer. Alternatively, the inner surface of the pan body is made of stainless steel, and the pre-treatment process is plasma spraying to form a plasma layer on the inner surface of the pan body; and the plasma layer forms the hard layer. The material sprayed onto the inner surface of the pan body through plasma spraying can be MCrAlY powder, or titanium powder, metal oxide powder, etc. (such as titanium oxide powder, aluminum oxide powder, and zirconium oxide). Alternatively, the inner surface of the pan body is made of aluminum or aluminum alloy, and the pre-treatment process is hard anodizing to form a hard oxide layer on the inner surface of the pan body; and the hard oxide layer forms the hard layer. Alternatively, the inner surface of the pan body is made of aluminum or aluminum alloy, and the pre-treatment process is plasma spraying to form a plasma layer on the inner surface of the pan body; and the plasma layer forms the hard layer. The material sprayed onto the inner surface of the pan body through plasma spraying can be MCrAlY powder, or titanium powder, metal oxide powder, etc. (such as titanium oxide powder, aluminum oxide powder, and zirconium oxide).

In the present disclosure, at the beginning of use, the inorganic nonstick coating and the dimples cooperate to achieve the nonstick effect. The inorganic nonstick coating can certainly achieve the nonstick effect, but the dimples help improve the nonstick effect. During cooking, at least some of the dimples store oil, and the food material is lifted by the convex portions outside the dimples in the pan. Compared to the dimples, the convex portions are protruding. After the pan is heated, the oil in the dimples is heated and surges upwards to lift the food material. The air not filled in oil inside the dimples is also heated and surges upwards, further lifting the food material. The design helps to improve the nonstick effect.

In the present disclosure, after a period of use, the inorganic nonstick coating is locally damaged. At this point, the closing and connection layer can achieve a certain nonstick effect. Especially when the closing and connection layer is made of polysilazane, polysilazane can achieve a good nonstick effect. In addition, polysilazane has a good hardness after sintering, which can avoid damage for a period of time. The closing and connection layer seals the pores of the hard layer to prevent oil from penetrating into the pores of the hard layer. Therefore, even when the inorganic nonstick coating is damaged, a considerable amount of oil can still be stored in the dimples, ensuring that the oil stored in the dimples surge upwards after being heated to lift the food. In addition, the closing and connection layer is transparent, and even if the inorganic nonstick coating is damaged, it does not affect the visual effect of the pan body.

In the present disclosure, after further use for a period of time, the closing and connection layer is also damaged. At this point, the hard layer plays a nonstick role at positions where the inorganic nonstick coating and the closing and connection layer are damaged. The hard layer is formed by the pores. Therefore, after the inorganic nonstick coating and the closing and connection layer are damaged, the oil enters and is stored in the pores of the hard layer. In the next use, when the pan is heated, the oil stored in the pores comes out to achieve a nonstick effect. Due to the hardness of the hard layer reaching 500 HV or more, even if the hard layer is exposed and hit by a spatula for a long time, it will not be damaged and can be used for a long time.

The present disclosure has the following beneficial effects. Firstly, the closing and connection layer enters a part of the pores of the hard layer to firmly bond to the hard layer, while the inorganic nonstick coating is bonded to the closing and connection layer and can be firmly bonded to the inner surface of the pan body through the closing and connection layer. Secondly, as analyzed above, the nonstick pan of the present disclosure can achieve good nonstick effect during initial use, can still achieve good nonstick effect after long-term use, and can be used for a long time.

### BRIEF DESCRIPTION OF THE DRAWINGS

FIG. 1 is a top view of a nonstick pan according to the present disclosure; and

FIG. 2 is a partial section view of the nonstick pan according to the present disclosure.

### DETAILED DESCRIPTION OF THE EMBODIMENTS

The present disclosure is described in further detail below with reference to the drawings and specific implementations.

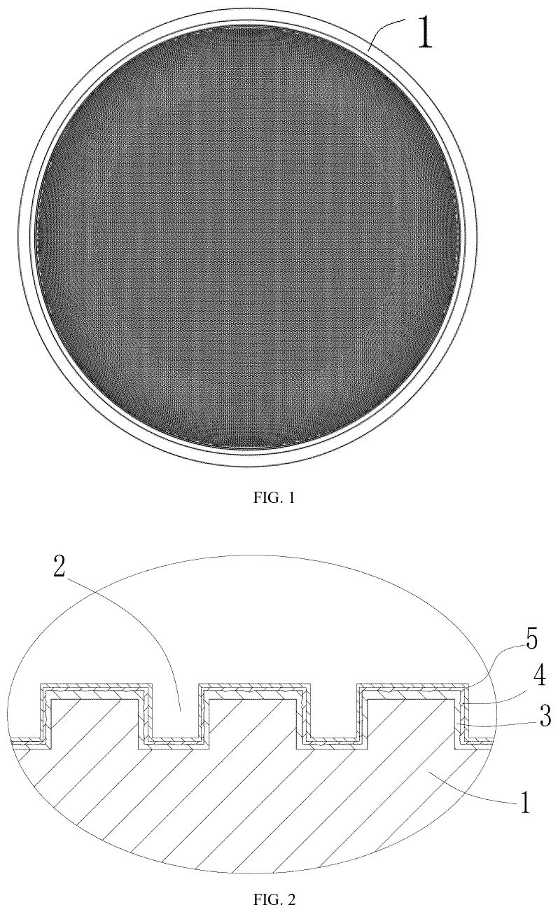

As shown in FIGS. 1 and 2, a nonstick pan includes metal pan body 1. An inner surface of the pan body 1 is provided with dimples 2 to form a concave-convex portion on the inner surface of the pan body 1.

The pan body 1 is subject to a pre-treatment process to form hard layer 3 with pores on the inner surface of the pan body 1. The hard layer 3 has a hardness of 500 HV or above.

The hard layer 3 is covered with transparent closing and connection layer 4 to seal the pores of the hard layer 3. The closing and connection layer 4 partially enters a part of the pores of the hard layer 3 to firmly bond to the hard layer 3.

The closing and connection layer 4 is sprayed with inorganic nonstick coating 5, and the inorganic nonstick coating 5 is bonded to the closing and connection layer 4.

In an embodiment, the dimples 2 are uniformly distributed on the inner surface of the pan body 1. The dimples 2 have a maximum width of 0.5 mm-1.5 mm, a spacing of 0.3 mm-1 mm, and a depth of 0.05 mm-0.15 mm.

The maximum width of the dimples 2 reflects the size of the dimples 2 in terms of width. The maximum width of the dimples 2 cannot be too large or too small. If the size of the dimples 2 in terms of width is too large, the oil level that can be stored in the dimples 2 will be too low, making it hard for the oil to surge to a level to lift the food. If the size of the dimples 2 in terms of width is too small, the amount of oil that can be stored in the dimples 2 will be too small, and the oil can hardly surge to the level to lift the food. Preferably, the dimples 2 are circular, and the maximum width of the dimples 2 is their diameter. The spacing between the dimples 2 reflects the proportion of the dimples 2 in the entire concave-convex portion in terms of area. The spacing between the dimples 2 cannot be too large or too small. If the spacing between the dimples 2 is too small, the lifting effect of the inner side of the pan outside the dimples 2 (i.e. the convex portions relative to the dimples) on the food material will be greatly weakened, and the food material can hardly be lifted by the surging oil or air after sinking into the dimples 2. If the spacing between the dimples 2 is too large, the amount of oil and air that can be stored in the dimples 2 is insufficient, and the oil or air that surges in the pan after heating cannot lift the food material. The depth of the dimples 2 cannot be too large or too small. If the depth of the dimples 2 is too large, the oil stored in the dimples 2 will sink to the bottom of the dimples, making it hard to surge to the level to lift the food material. If the depth of the dimples 2 is too small, the amount of oil stored in the dimples 2 will be too small, and the coil can hardly surge to the level to lift the food material. In summary, through long-term exploration, the present disclosure ultimately defines relevant parameters of the dimples 2 to achieve the best nonstick effect as follows. The dimples 2 are evenly distributed on the inner surface of the pan body 1, with a maximum width of 0.5 mm-1.5 mm, a spacing of 0.3 mm-1 mm, and a depth of 0.05 mm-0.15 mm.

In an embodiment, the hard layer 3 has a thickness of 25 μm-45 μm. The hard layer 3 with this thickness ensures that the pores store a sufficient amount of oil, such that after the inorganic nonstick coating 5 and the closing and connection layer 4 are damaged, there is enough oil to emerge from the pores when the pan is heated to achieve a nonstick effect.

In an embodiment, the closing and connection layer 4 has a thickness of 1 μm to 2 μm, ensuring that the closing and connection layer 4 effectively connects the hard layer 3 to the inorganic nonstick coating 5.

In an embodiment, the inorganic nonstick coating 5 has a thickness of 0.5 μm-1.5 μm. If the thickness of the inorganic nonstick coating 5 is too large, it will be hard for the inorganic nonstick coating to effectively bond to the closing and connection layer 4. If the inorganic nonstick coating is too thin, it will be hard to achieve good nonstick effect and will be quickly damaged during use.

In an embodiment, the closing and connection layer 4 is made of polysilazane. Polysilazane can achieve a certain nonstick effect and has good wear resistance and high temperature resistance. After the inorganic nonstick coating is coated, sintering is performed. In this way, a three-dimensional cross-linked structure formed by polysilazane is well connected to the inorganic nonstick coating 5 and the hard layer 3, thereby effectively bonding the inorganic nonstick coating 5 to the inner surface of the pan body 1.

The inorganic nonstick coating 5 can be made of a commonly used material in e prior art, such as silicon nitride, silicon dioxide, aluminum oxide, and silicon carbide. In an embodiment, the inorganic nonstick coating 5 is connected to the closing and connection layer 4 through a sintering process, which makes the inorganic nonstick coating 5 firmly bonded to the closing and connection layer 4. Usually, after the material of the inorganic nonstick coating is sprayed onto the closing and connection layer 4, sintering is performed at 280° C.-320 ° C. for 8 min-12 min, thereby firmly bonding the inorganic nonstick coating 5 to the polysilazane.

In an embodiment, the inner surface of the pan body 1 is made of iron, and the pre-treatment process is gas nitriding to form a nitrided layer on the inner surface of the pan body 1. The nitrided layer forms the hard layer 3. The nitrided layer formed by gas nitriding can achieve a hardness of 500 HV or above.

In an embodiment, the inner surface of the pan body 1 is made of stainless steel, and the pre-treatment process is plasma spraying to form a plasma layer on the inner surface of the pan body. The plasma layer forms the hard layer 3. The material sprayed onto the inner surface of the pan body through plasma spraying can be metal chromium aluminum yttrium (MCrAlY) powder, or titanium powder, metal oxide powder, etc. (such as titanium oxide powder, aluminum oxide powder, and zirconium oxide). The plasma layer formed by plasma spraying can achieve a hardness of 500 HV or more.

In another embodiment, the inner surface of the pan body 1 is made of aluminum or aluminum alloy, and the pre-treatment process is hard anodizing to form a hard oxide layer on the inner surface of the pan body 1. The hard oxide layer forms the hard layer 3. The hard oxide layer formed by hard anodizing can achieve a hardness of 500 HV or more.

In another embodiment, the inner surface of the pan body 1 is made of aluminum or aluminum alloy, and the pre-treatment process is plasma spraying to form a plasma layer on the inner surface of the pan body 1. The plasma layer forms the hard layer 3. The material sprayed onto the inner surface of the pan body through plasma spraying can be MCrAlY powder, or titanium powder, metal oxide powder, etc. (such as titanium oxide powder, aluminum oxide powder, and zirconium oxide). The plasma layer formed by plasma spraying can achieve a hardness of 500 HV or more.

In this specification, descriptions of reference terms such as “one embodiment”, “some embodiments”, “an example”, “a specific example”, and “some examples” indicate that specific features, structures, materials, or characteristics described in combination with the embodiment(s) or example(s) are included in at least one embodiment or example of the present disclosure. In this specification, the schematic representations of the above terms do not necessarily refer to the same embodiment or example. In addition, the specific features, structures, materials, or characteristics described may be combined in any suitable manner in any one or more embodiments or examples.

The above illustrates the implementation of the present disclosure. However, the present disclosure is not limited to the aforementioned implementation. Any modifications, equivalent substitutions, improvements, etc. made within the spirit and scope of the present disclosure should be included within the protection scope of the present disclosure.

1. A nonstick pan, comprising a metal pan body, wherein an inner surface of the pan body is provided with dimples to form a concave-convex portion on the inner surface of the pan body;
the pan body is subject to a pre-treatment process to form a hard layer with pores on the inner surface of the pan body, and the hard layer has a hardness of 500 HV or above;
the hard layer is covered with a transparent closing and connection layer to seal the pores of the hard layer, and the transparent closing and connection layer partially enters a part of the pores of the hard layer to firmly bond to the hard layer; and
the transparent closing and connection layer is sprayed with an inorganic nonstick coating, and the inorganic nonstick coating is bonded to the transparent closing and connection layer.

2. The nonstick pan according to claim 1, wherein the dimples are uniformly distributed on the inner surface of the pan body; and the dimples have a maximum width of 0.5 mm-1.5 mm, a spacing of 0.3 mm-1 mm, and a depth of 0.05 mm-0.15 mm;
the hard layer has a thickness of 25 μm-45 μm;
the transparent closing and connection layer has a thickness of 1 μm-2 μm; and
the inorganic nonstick coating has a thickness of 0.5 μm-1.5 μm.

3. The nonstick pan according to claim 1, wherein the transparent closing and connection layer is made of polysilazane.

4. The nonstick pan according to claim 3, wherein after a material of the inorganic nonstick coating is sprayed onto the transparent closing and connection layer, sintering is performed at 280° C.-320° C. for 8 min-12 min.

5. The nonstick pan according to claim 2, wherein the inner surface of the pan body is made of iron, and the pre-treatment process is gas nitriding to form a nitrided layer on the inner surface of the pan body; and the nitrided layer forms the hard layer.

6. The nonstick pan according to claim 2, wherein the inner surface of the pan body is made of stainless steel, and the pre-treatment process is plasma spraying to form a plasma layer on the inner surface of the pan body; and the plasma layer forms the hard layer.

7. The nonstick pan according to claim 2, wherein the inner surface of the pan body is made of aluminum or aluminum alloy, and the pre-treatment process is hard anodizing to form a hard oxide layer on the inner surface of the pan body; and the hard oxide layer forms the hard layer.

8. The nonstick pan according to claim 2, wherein the inner surface of the pan body is made of aluminum or aluminum alloy, and the pre-treatment process is plasma spraying to form a plasma layer on the inner surface of the pan body; and the plasma layer forms the hard layer.
